(19) United States
(12) Patent Application Publication
(10) Pub. No.: US 2018/0093365 A1
(43) Pub. Date: Apr. 5, 2018

(54) VACUUM DEVICE AND MULTISTAGE PRESSURE-SWITCHING DEVICE THEREOF

(71) Applicant: METAL INDUSTRIES RESEARCH & DEVELOPMENT CENTRE, Kaohsiung (TW)

(72) Inventors: Hao-Jhen CHANG, Chiayi County (TW); Chia-Chu HUANG, Kaohsiung City (TW); Chih-Chin WEN, Hsinchu City (TW); Shi-Wei LIN, Kaohsiung City (TW); Cheng-Chang CHIU, Pingtung County (TW)

(21) Appl. No.: 15/347,791

(22) Filed: Nov. 10, 2016

(30) Foreign Application Priority Data
Oct. 3, 2016 (TW) 105131933

(51) Int. Cl. B25B 11/00; G05D 16/18

(52) U.S. Cl. CPC B25B 11/005; G05D 16/18

(57) ABSTRACT

A vacuum device includes a negative pressure pump and a vacuum-switching device. The vacuum-switching device includes a cylinder, a piston and a piston-driving device. The cylinder has a first hole row, which includes a plurality of first vacuum suction holes. The cylinder has two through holes at two opposite ends, wherein either one of the two through holes is connected with a negative pressure pump. The piston is slidably connected within a hollow chamber inside the cylinder. The piston-driving device enables the piston to be slid back and forth so as to define two different-pressured chambers, thereby switching the first vacuum suction holes progressively to a different pressure.

### RELATED APPLICATIONS

This application claims priority to Taiwan Application Serial Number 105131933, filed Oct. 3, 2016, which is herein incorporated by reference.

### BACKGROUND

### Field of Invention

The present invention relates to a component of a vacuum device. More particularly, the present invention relates to a multistage pressure-switching device.

### Description of Related Art

A prior vacuum system provides a vacuum-switching function, which is required to manually or install a series of solenoid valves to execute the vacuum-switching. Manual vacuum-switching can only be used in pre-planned regions, and the regions cannot be switched in action.

If the solenoid valves in series are utilized in switching multistage vacuum, the piping configuration is complicated to assemble, difficult to control, and the total cost is high due to the large number of components. Because such devices are required to switch the vacuum through the multiple solenoid valves' action, multistage switching must be paired up with a number of solenoid valves. In case a large suction chuck is equipped with suction holes along about 30 rows, at least 30 sets of solenoid valves are needed to be paired up with the 30 rows of suction holes. Therefore, the flow control and software design are also relatively complicated to achieve a workable piping configuration. And it is limited to obtain enough space for the power distribution and piping configuration.

Also, if the vacuum-switching is executed by utilizing a cam against a mechanical valve to achieve, a high degree of resolution cannot be achieved due to the cam design limitation, and the apparatus is only for the vacuum-switching device with a small number of channels and low-resolution vacuum requirements. In addition, the application will be limited due to the power distribution and piping configuration.

In view of the above-described problems, the improvement is needed for the prior multistage vacuum-switching device.

### SUMMARY

The present invention provides a multistage vacuum-switching device to deal with the problems in the prior art.

In accordance with an object of the present invention, a multistage vacuum-switching device includes a cylinder, a piston and a piston-driving device. The cylinder has a first hole row, which includes a plurality of first vacuum suction holes. The cylinder has two through holes at two opposite ends, wherein either one of the two through holes is connected with a negative pressure source. The piston is slidably connected within a hollow chamber inside the cylinder. The piston-driving device enables the piston to be slid back and forth so as to define two different-pressured chambers, thereby switching the first vacuum suction holes progressively to a different pressure.

In accordance with another object of the present invention, a vacuum device includes a negative pressure pump and a vacuum-switching device. The vacuum-switching device includes a cylinder, a piston and a piston-driving device. The cylinder has a first hole row, which includes a plurality of first vacuum suction holes. The cylinder has two through holes at two opposite ends, wherein either one of the two through holes is connected with a negative pressure pump. The piston is slidably connected within a hollow chamber inside the cylinder. The piston-driving device enables the piston to be slid back and forth so as to define two different-pressured chambers, thereby switching the first vacuum suction holes progressively to a different pressure.

In accordance with another embodiment, the cylinder includes a cylinder body, a front cover and a rear cover, the two through holes are located on the front cover and the rear cover respectively, the first hole row is located on the cylinder body.

In accordance with another embodiment, the piston-driving device includes a motor and a lead-screwed rod, the piston is rotatably connected with the lead-screwed rod, the motor drives the lead-screwed rod to rotate by a belt so as to enable the piston to be slid back and forth within the hollow chamber inside the cylinder.

In accordance with another embodiment, the cylinder further includes a second hole row, the second hole row having a plurality of second vacuum suction holes, the first and second vacuum suction holes are misaligned and have an equal pitch between immediate-adjacent two of the first and second vacuum suction holes along a long axis of the cylinder.

In accordance with another embodiment, the cylinder further includes a third hole row having a plurality of third vacuum suction holes and a fourth hole row having a plurality of fourth vacuum suction holes, each of the first vacuum suction holes is aligned with a corresponding one of the third vacuum suction holes, each of the second vacuum suction holes is aligned with a corresponding one of the fourth vacuum suction holes, the third and fourth vacuum suction holes are misaligned along a long axis of the cylinder.

In accordance with another embodiment, the vacuum device further includes a suction chuck, which has a plurality of flow channels which do not communicate with one another, each of the flow channels has an end opening connected with a corresponding one of the first vacuum suction holes.

In accordance with another embodiment, the vacuum device further includes a suction chuck, which has a plurality of flow channels, which do not communicate with one another, each of the flow channels has two openings at two opposite ends, and each opening of the flow channels is connected with a corresponding one of the first, second, third, fourth vacuum suction holes.

Thus, the vacuum-switching device disclosed herein adopts the design of the cylinder body piston, lead-screwed rod and so on to achieve the goal of progressively switching pressure between the negative pressure and environment pressure, and can replace the configuration of the traditional vacuum-switching using multiple solenoid valves. It can also be used with suction chucks such that the combination can be used in the required process. This is no need to configure a large number of parallel solenoid valves to achieve a multistage vacuum-switching device so as to save space, reduce costs and reduce failure rate.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 illustrates a perspective view of a multistage vacuum-switching device according to one embodiment of this invention;

FIG. 2 illustrates a sectional view of the multistage vacuum-switching device in FIG. 1;

FIG. 3 illustrates an exploded view of the multistage vacuum-switching device in FIG. 1;

FIG. 4 illustrates a perspective view of a suction chuck according to one embodiment of this invention;

FIG. 5 illustrates a perspective view of a multistage vacuum-switching device according to another embodiment of this invention; and

FIG. 6 illustrates a perspective view of a suction chuck according to another embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

In order to solve the above-mentioned problems, the present invention provides a multistage vacuum-switching device including a cylinder, a piston, a lead-screwed rod, and a servo motor. A front cover and a rear cover of the cylinder are both equipped with a through hole used to be connected to a negative pressure source. A cylinder body of the cylinder may be equipped with two or more rows of vacuum suction holes. A vacuum can be generated in each of the vacuum suction holes by supplying the negative pressure to the cylinder, e.g., connected to the negative pressure source. The piston rotatably connected with the lead-screwed rod, which is driven by a belt, and can be slid back and forth within the cylinder body. The piston can progressively switch each vacuum suction hole between a negative pressure and an environment pressure when the piston is slid back and forth. The device can greatly reduce the demand for the solenoid valves utilized in the conventional vacuum-switching device and simplify the design complexity of the control program software.

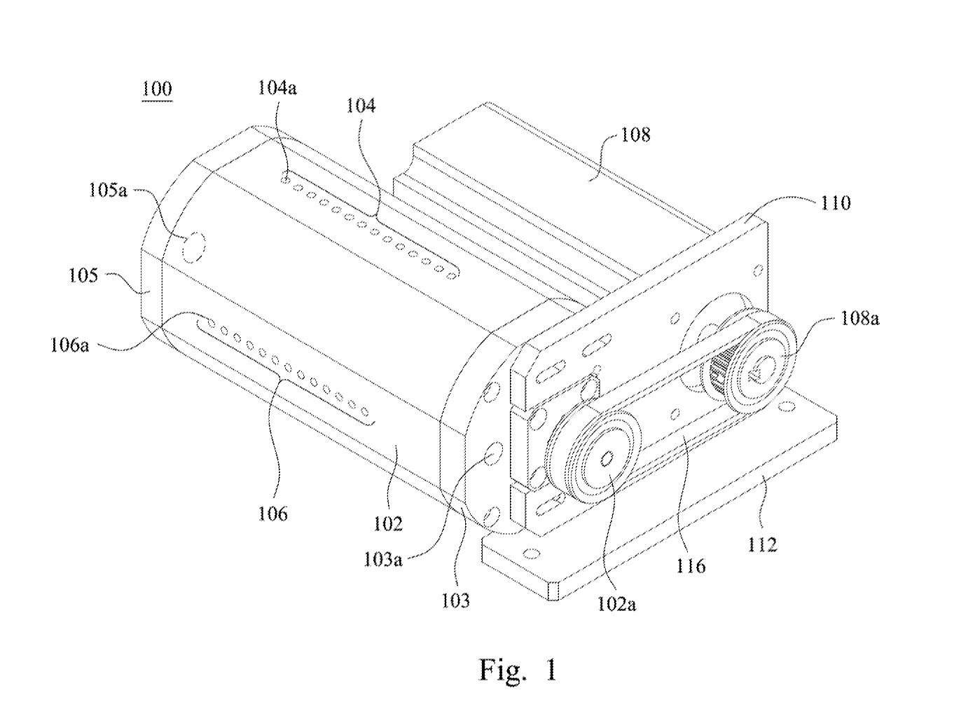

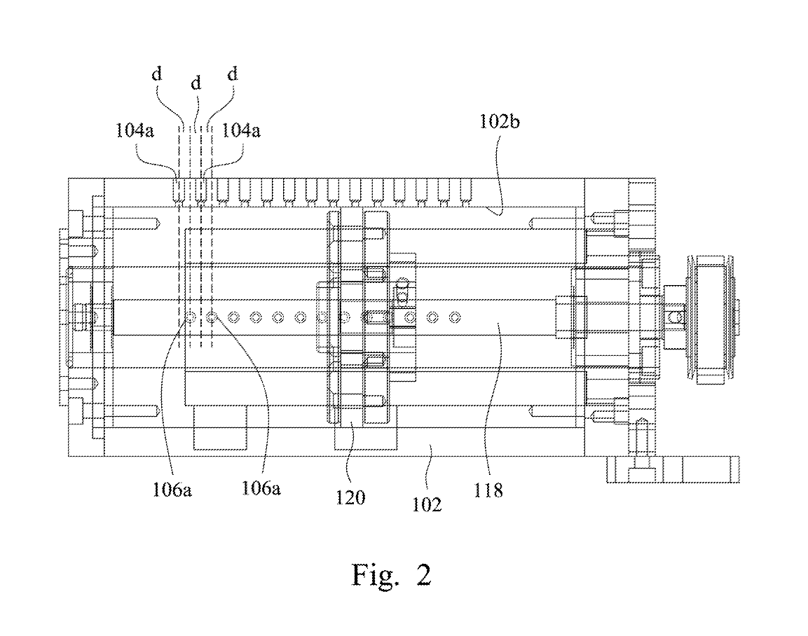

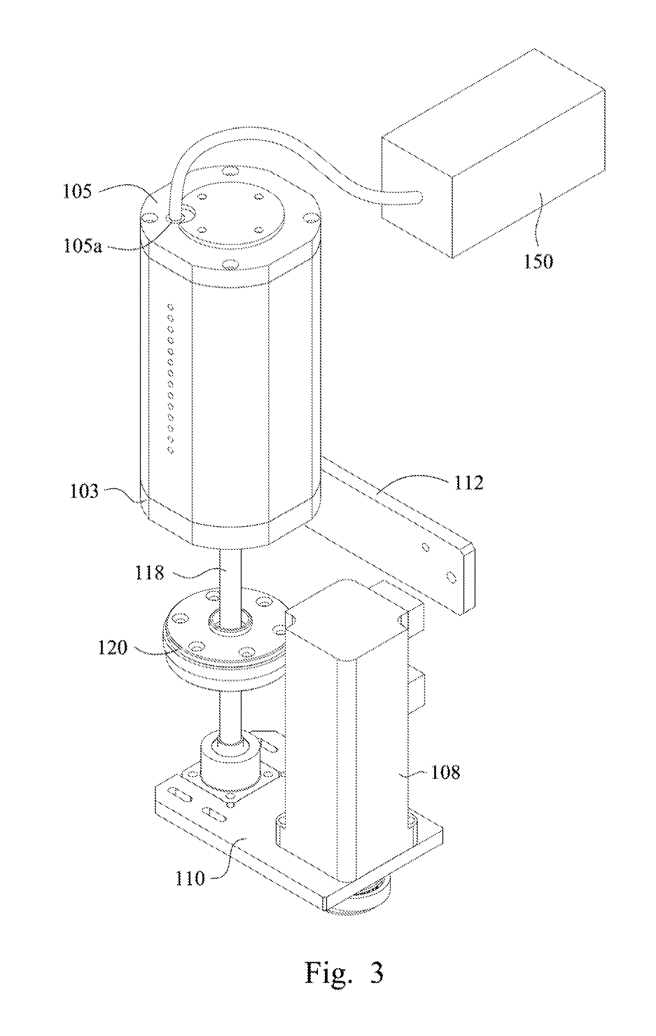

Referring to FIG. 1, FIG. 2 and FIG. 3, FIG. 1 illustrates a perspective view of a multistage vacuum-switching device according to one embodiment of this invention, FIG. 2 illustrates a sectional view of the multistage vacuum-switching device in FIG. 1, and FIG. 3 illustrates an exploded view of the multistage vacuum-switching device in FIG. 1. A vacuum-switching device 100 includes a cylinder and a piston-driving device. The cylinder includes a cylinder body 102, a front cover 103 and a rear cover 105 assembled as a whole, but not being limited to the embodiment disclosed herein. As long as the cylinder allows a piston to be slid back and forth within, it can be used in this invention. The cylinder body 102 has a first hole row 104. The first hole row 104 includes a plurality of vacuum suction holes 104a equally spaced along a straight line, i e., along a row. In order to enable the vacuum suction holes 104a to be easily connected with a tube, a pitch between adjacent vacuum suction holes 104a should be large enough for assembly. If more vacuum suction holes are needed, they can be arranged into multiple rows of holes, e.g., a second hole row 106, which includes vacuum suction holes 106a equally spaced along a straight line, as illustrated in FIG. 1 is added, so as to keep the cylinder body 102 to be short.

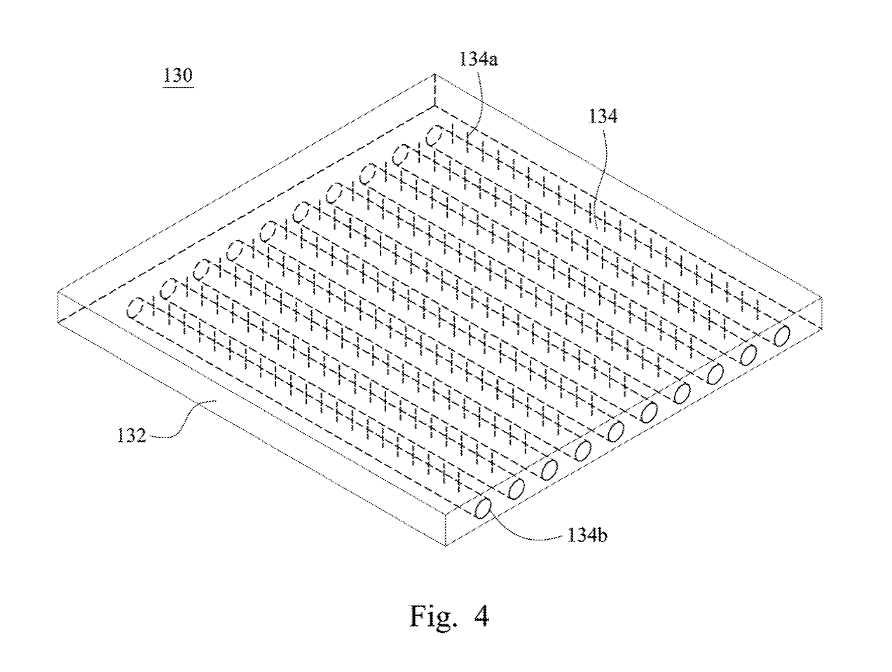

Those vacuum suction holes (104a, 106a) allow a vacuum suction member, e.g., a suction chuck 130 as illustrated in FIG. 4, to be attached thereon to provide a negative pressure. In an embodiment, the front cover 103 or the rear cover 105 is equipped with a through hole (103a/105a) to be connected to a negative pressure source, e.g., a negative pressure pump 150 as illustrated in FIG. 3. When either one of the through holes (103a, 105a) is connected to the negative pressure source, the other one is connected to an environment pressure. In another embodiment, the through hole is located on the cylinder body (not illustrated in drawings).

In this embodiment, the cylinder still includes a piston 120 to be slidably connected within a hollow chamber inside the cylinder body 102. The piston-driving device is used to drive the piston 120 to be slid back and forth within the hollow chamber inside cylinder body 102. When the piston 120 is slid to a position, the hollow chamber inside cylinder body 102 is divided into two chambers of a negative pressure chamber, i.e., being connected to the negative pressure source via the through hole, and an environment pressure chamber, i.e., being connected to the outside environment via the through hole. When the vacuum suction holes (104a, 106a) are equally spaced on the cylinder body 102, and the piston 120 is slid back and forth within the hollow chamber inside cylinder body 102, i.e., the piston 120 is airtight in contact with an inner surface 102b of the cylinder body 102, the hollow chamber is divided into two chambers of a negative pressure and an environment pressure by the slid piston 120 so as to switch part of the vacuum suction holes and part of the vacuum suction member progressively to a different pressure (e.g., between the negative pressure and the environment pressure).

When the vacuum suction holes are arranged along two rows on the cylinder body 102, these two hole rows are in parallel with each other, holes along one row is misaligned with holes along the other row (along a long axis of the cylinder body 102), and have an equal pitch “d” between immediate-adjacent two vacuum suction holes along the long axis of the cylinder body 102 (as illustrated in FIG. 2). If more vacuum suction holes are still needed, the vacuum suction holes may be arranged along three or more rows on the cylinder body 102 for tube assembly. Basically, the vacuum suction holes are arranged along a long axis of the cylinder body 102 as illustrated in the drawings.

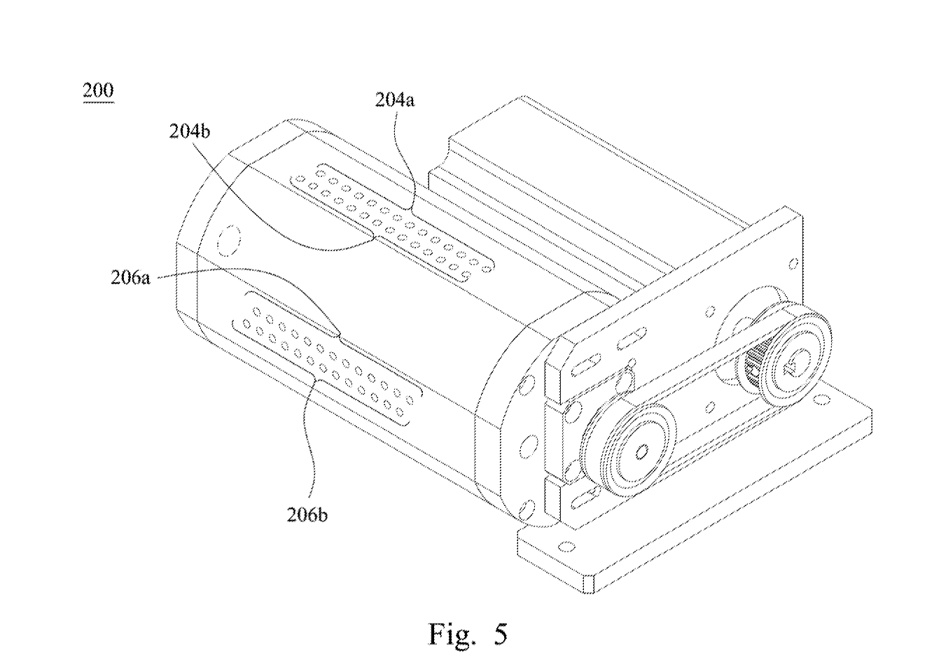

FIG. 5 illustrates a perspective view of a multistage vacuum-switching device 200 according to another embodiment of this invention, wherein the cylinder has four hole row, i e., a first hole row 204a, a second hole row 204b, a third hole row 206a and a fourth hole row 206b are in parallel with one another. Each vacuum suction hole of the first hole row 204a is aligned with a corresponding one of the third hole row 206a along a long axis of the cylinder body 102. Each vacuum suction hole of the second hole row 204b is aligned with a corresponding one of the fourth hole row 206b along a long axis of the cylinder body 102. The vacuum suction holes of the first, third hole rows (204a, 206a) are misaligned with the vacuum suction holes of the second, fourth hole rows (204b, 206b) along a long axis of the cylinder body 102.

Referring to FIG. 1 and FIG. 3 again, the piston-driving device includes a motor 108 and a lead-screwed rod 118, and the piston 120 is rotatably connected with the lead-screwed rod 118 such that the motor 108 drives the lead-screwed rod 118 to rotate, thereby enabling the piston 120 to be slid back and forth within the hollow chamber of the cylinder body 102. In this embodiment, the motor 108 and the cylinder body 102 are arranged side by side and screwed on a front board 110 and a bottom board 112. The motor 108 drives the lead-screwed rod 118 to rotate by a belt 116 so as to enable the piston to be slid back and forth within the hollow chamber the cylinder body 102. In particular, a rotor wheel 108a of the motor 108 drives the belt wheel 102a to rotate via the belt 116, thereby rotating the lead-screwed rod 118 connected to the belt wheel 102a.

The piston-driving device may also be an air pressure driving device, a hydraulic driving device, a piezoelectric device, a magnetic device or a manual device. In addition, the piston-driving mechanism may be a lead-screwed rod or other reciprocating mechanisms.

FIG. 4 illustrates a perspective view of a suction chuck according to one embodiment of this invention. A suction chuck 130 may be used with the vacuum-switching device 100. A main body 132 of the suction chuck 130 has a plurality of flow channels 134, which do not communicate with one another. Each flow channel 134 has several branch flow paths 134a communicating with an upper surface of the body 132. Therefore, when the negative pressure is applied to each of the flow channels 134, the upper surface of the body 132 suctions a target by the negative pressure produced by the plurality of branch flow paths 134a. Each of the flow channels 134 has an end opening 134b connected with a corresponding one of the vacuum suction holes (104a, 106a). Referring to FIG. 2 and FIG. 4, the vacuum suction holes 104a and the vacuum suction holes 106a, e.g., from left to right and alternate vacuum suction holes (104a, 106a), may be connected to the end openings 134b of the flow channels 134, e.g., from top to bottom or from bottom to top. When the piston 120 is slid back and forth within the hollow chamber inside cylinder body 102, the hollow chamber is divided into two chambers of a negative pressure and an environment pressure by the slid piston 120 such that part of the vacuum suction holes and the flow channels 134 are of the negative pressure, the other part of the vacuum suction holes and the flow channels 134 are of the environment pressure, and the flow channels 134 within the suction chuck 130 are progressively switched to a different pressure (e.g., between the negative pressure and the environment pressure).

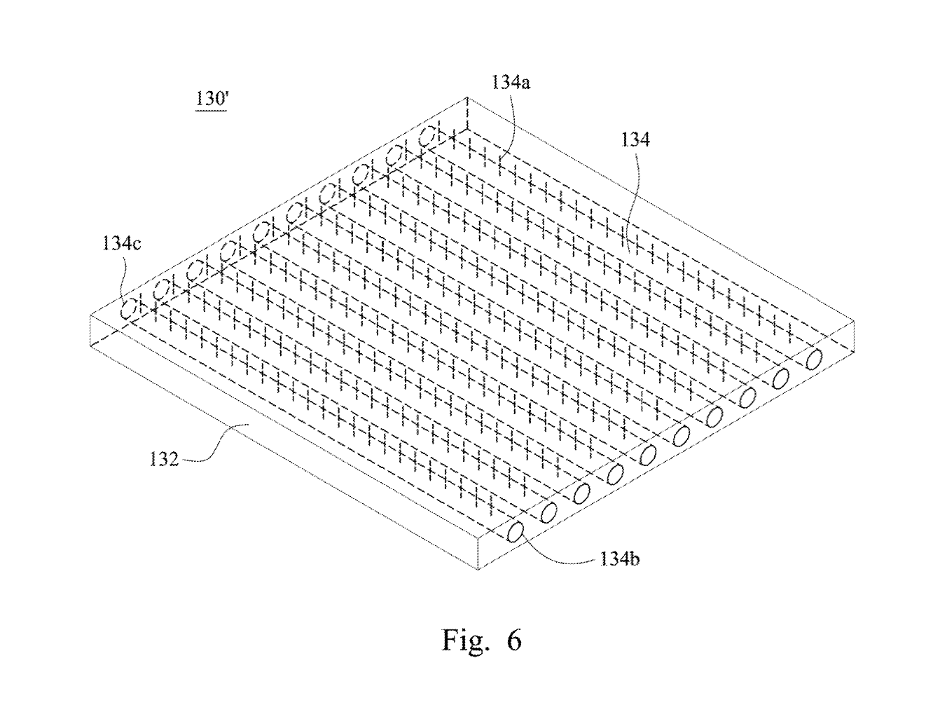

FIG. 6 illustrates a perspective view of a suction chuck according to another embodiment of this invention. The suction chuck 130′ is different from the suction chuck 130 by the feature that each flow channel 134 within the suction chuck 130′ has two openings (134b, 134c) at two opposite ends. When the suction chuck 130′ is paired up with the vacuum-switching device 200, two openings (134b, 134c) of the flow channels 134 may be connected with the first, second, third, fourth hole rows (204a, 204b, 206a, 206b) alternately to configure piping, thereby enhancing the negative vacuum suction force of the suction chuck 130′.

In addition, the multistage vacuum-switching device herein may also be utilized to be multistage pressure-switching device, which switches between two different pressures (positive pressures, negative pressures or environment pressures) and not limited to “between a negative pressure and a environment pressure”. The “vacuum suction hole” may be referred to as “pressure-applied hole” while being applied in the multistage vacuum-switching device.

In sum, the vacuum-switching device disclosed herein adopts the design of the cylinder body, piston, lead-screwed rod and so on to achieve the goal of progressively switching pressure between the negative pressure and environment pressure, and can replace the configuration of the traditional vacuum-switching using multiple solenoid valves. It can also be used with suction chucks such that the combination can be used in the required process. There is no need to configure a large number of parallel solenoid valves to achieve a multistage vacuum-switching device so as to save space, reduce costs and reduce failure rate.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A multistage vacuum-switching device comprising:
a cylinder having a first hole row, the first hole row having a plurality of first vacuum suction holes, the cylinder having two through holes at two opposite ends, wherein either one of the two through holes is connected with a negative pressure source;
a piston slidably connected within a hollow chamber inside the cylinder; and
a piston-driving device enabling the piston to be slid back and forth so as to define two different-pressured chambers, thereby switching the first vacuum suction holes progressively to a different pressure.

2. The multistage vacuum-switching device of claim 1, wherein the cylinder comprises a cylinder body, a front cover and a rear cover, the two through holes are located on the front cover and the rear cover respectively, the first hole row is located on the cylinder body.

3. The multistage vacuum-switching device of claim 1, wherein the piston-driving device comprises a motor and a lead-screwed rod, the piston is rotatably connected with the lead-screwed rod, the motor drives the lead-screwed rod to rotate by a belt so as to enable the piston to be slid back and forth within the hollow chamber inside the cylinder.

4. The multistage vacuum-switching device of claim 1, wherein the cylinder further comprises a second hole row, the second hole row having a plurality of second vacuum suction holes, the first and second vacuum suction holes are misaligned and have an equal pitch between immediate-adjacent two of the first and second vacuum suction holes along a long axis of the cylinder.

5. The multistage vacuum-switching device of claim 4, wherein the cylinder further comprises a third hole row having a plurality of third vacuum suction holes and a fourth hole row having a plurality of fourth vacuum suction holes, each of the first vacuum suction holes is aligned with a corresponding one of the third vacuum suction holes along the long axis of the cylinder, each of the second vacuum suction holes is aligned with a corresponding one of the fourth vacuum suction holes along the long axis of the cylinder, the third and fourth vacuum suction holes are misaligned along the long axis of the cylinder.

6. A vacuum device comprising:
a negative pressure pump; and
a vacuum-switching device comprising:
a cylinder having a first hole row the first hole row having a plurality of first vacuum suction holes, the cylinder having two through holes at two opposite ends, wherein either one of the two through holes is connected with the negative pressure pump;
a piston slidably connected within a hollow chamber inside the cylinder; and
a piston-driving device enabling the piston to be slid back and forth so as to define two different-pressured chambers, thereby switching the first vacuum suction holes progressively to a different pressure.

7. The vacuum device of claim 6 further comprising a suction chuck, wherein the suction chuck has a plurality of flow channels, which do not communicate with one another, each of the flow channels has an end opening connected with a corresponding one of the first vacuum suction holes.

8. The vacuum device of claim 6, wherein the cylinder further comprises a second hole row, the second hole row having a plurality of second vacuum suction holes, the first and second vacuum suction holes are misaligned and have an equal pitch between immediate-adjacent two of the first and second vacuum suction holes along a long axis of the cylinder.

9. The vacuum device of claim 8, wherein the cylinder further comprises a third hole row having a plurality of third vacuum suction holes and a fourth hole row having a plurality of fourth vacuum suction holes, each of the first vacuum suction holes is aligned with a corresponding one of the third vacuum suction holes along the long axis of the cylinder, each of the second vacuum suction holes is aligned with a corresponding one of the fourth vacuum suction holes along the long axis of the cylinder, the third and fourth vacuum suction holes are misaligned along the long axis of the cylinder.

10. The vacuum device of claim 9 further comprising a suction chuck, wherein the suction chuck has a plurality of flow channels, which do not communicate with one another, each of the flow channels has two openings at two opposite ends, and each opening of the flow channels is connected with a corresponding one of the first, second, third, fourth vacuum suction holes.

11. A multistage pressure-switching device comprising:
a cylinder having a hole row, the hole row having a plurality of pressure-applied holes, the cylinder having two through holes at two opposite ends, wherein either one of the two through holes is connected with a pressure source;
a piston slidably connected within a hollow chamber inside the cylinder; and
a piston-driving device enabling the piston to be slid back and forth so as to define two different-pressured chambers, thereby switching the pressure-applied holes progressively to a different pressure.

12. The multistage pressure-switching device of claim 1, wherein the cylinder comprises a cylinder body, a front cover and a rear cover, the two through holes are located on the front cover and the rear cover respectively, the hole row is located on the cylinder body.

13. The multistage pressure-switching device of claim 1, wherein the piston-driving device comprises a motor and a lead-screwed rod, the piston is rotatably connected with the lead-screwed rod, the motor drives the lead-screwed rod to rotate by a belt so as to enable the piston to be slid back and forth within the hollow chamber inside the cylinder.
